(19) United States
(12) Patent Application Publication
(10) Pub. No.: US 2010/0058048 A1
(43) Pub. Date: Mar. 4, 2010

(54) Profile Adjustment Module For Use With Data Processing System

(75) Inventors: Michael Casey Gotcher, Lakeway, TX (US); Raymond Farrell Dumbeck, Austin, TX (US)

Correspondence Address: HAMILTON & TERRILE, LLP - AMD, P.O. BOX 203518, AUSTIN, TX, 78720, US

(73) Assignee: Advanced Micro Devices, Inc.

(21) Appl. No.: 12/198,372

(22) Filed: Aug. 26, 2008

(51) Int. Cl. G06F 9/24

(52) U.S. Cl. 713/100

(57) ABSTRACT

A profile adjustment module which enables customization of the profiles within a computer system. The profile adjustment module enables gaming or entertainment enthusiast or customers an easy-to-use interface to tune their personal computer for maximum performance for a customized application such as a gaming or entertainment application. The interface of the profile adjustment module includes designated settings depending on the system make-up. When a customer selects a usage model such as a “Game on” usage model or an “Entertainment on” usage model, the profile adjustment module initiates a predetermined sequence of events including, but not limited to tuning the audio and video settings to peek experience settings (where the settings are specifically chosen to adjust the usage model).

### BACKGROUND OF THE INVENTION

1. Field of the Invention

The present invention relates to computer systems and more particularly to a profile adjustment module for use with a computer system.

2. Description of the Related Art

The role of computers continues to evolve as a tool used for communications and media applications. Personal computers offer many media applications for personal entertainment such as games, live television, personal video recording, playing or recording digital music, displaying or creating digital photographs, playing movies recorded on a DVD, etc.

It is known to grossly adjust settings within a computer system. These settings can include hardware settings such as processor clock speed, microcode setting such as whether to turn a hard disk drive on or off and software setting such as whether certain services are turned on or off.

One example of where it is desirable to adjust the settings of a computer system relates to computer systems that are used for executing games or entertainment applications. In each of these usage models, the user (who is often an enthusiast) desires the utmost performance from their personal computers (even mainstream enthusiasts). Mainstream enthusiasts and others will likely use their personal computers to execute multiple applications in addition to the gaming applications. These other applications can include productivity applications, email applications, internet applications, as well as server applications. Non-gaming and entertainment usage models may not require additional performance, but may require certain operation system services to be executed concurrently. These other applications are often accessed throughout the day, perhaps interspersed with execution of the gaming or entertainment application. Additionally, a personal computer gamer or entertainment enthusiast may also likely share this machine with others.

The information required to adjust these settings is often provided via enthusiast websites. For example, information regarding how to increase a processor clock speed might be available from a gaming enthusiast website. With the information obtained from the website, an enthusiast could then adjust these settings within their computer system by accessing the command lines that perform the particular function. These adjustments are often limited to a relatively small group of enthusiasts as performing the adjustments are not very user friendly.

Accordingly, it would be desirable to provide a mechanism to easily adjust profile setting within a computer system.

### SUMMARY OF THE INVENTION

In accordance with the present invention, a profile adjustment module is set forth which enables customization of the profiles within a computer system. The profile adjustment module enables gaming or entertainment enthusiast or customers an easy-to-use interface to tune their personal computer for maximum performance for a customized application such as a gaming or entertainment application. The interface of the profile adjustment module includes designated settings depending on the system make-up. When a customer selects a usage model such as a “Game on” usage model or an “Entertainment on” usage model, the profile adjustment module initiates a predetermined sequence of events including, but not limited to tuning performance of processor settings (e.g., overclocking the processor and memory) and tuning the audio and video settings to peek experience settings (where the settings are specifically chosen to adjust the usage model). Additionally, the profile adjustment module turns off unneeded applications and services not used for the usage model, further increasing CPU, GPU, and memory performance. When the customer completes executing the particular application (e.g., finishes playing a particular computer game), the user actuates a restore indicia to restore the computer system to its original configuration.

In addition, in certain embodiments, the profile adjustment module includes an online component which allows users to post system configurations, game settings, and high scores using a registry system such as that available at predetermined sites such as the website amd.game.com.

### BRIEF DESCRIPTION OF THE DRAWINGS

The present invention may be better understood, and its numerous objects, features, and advantages made apparent to those skilled in the art by referencing the accompanying drawings. The use of the same reference number throughout the several figures designates a like or similar element.

FIG. 1 shows a block diagram of a computer system having a media system in accordance with the present invention.

FIG. 2 shows a block diagram of a profile adjustment module.

FIG. 3 shows a flow chart of the operation of an install portion of a profile adjustment module.

FIG. 4 shows a flow chart of the operation of a use portion of a profile adjustment module.

FIG. 5 shows an example screen presentation of a profile selection operation of profile adjustment module.

FIG. 6 shows an example screen presentation of a profile creation operation of a profile adjustment module.

FIGS. 7A and 7B shows an example screen presentation of a software configuration option operation of a profile adjustment module.

FIG. 8 shows an example screen presentation of an edit profile operation of a profile adjustment module.

FIG. 9 shows a start and stop profile operation of a profile adjustment module.

FIG. 10 shows an example of a white list operation of a profile adjustment module.

### DETAILED DESCRIPTION

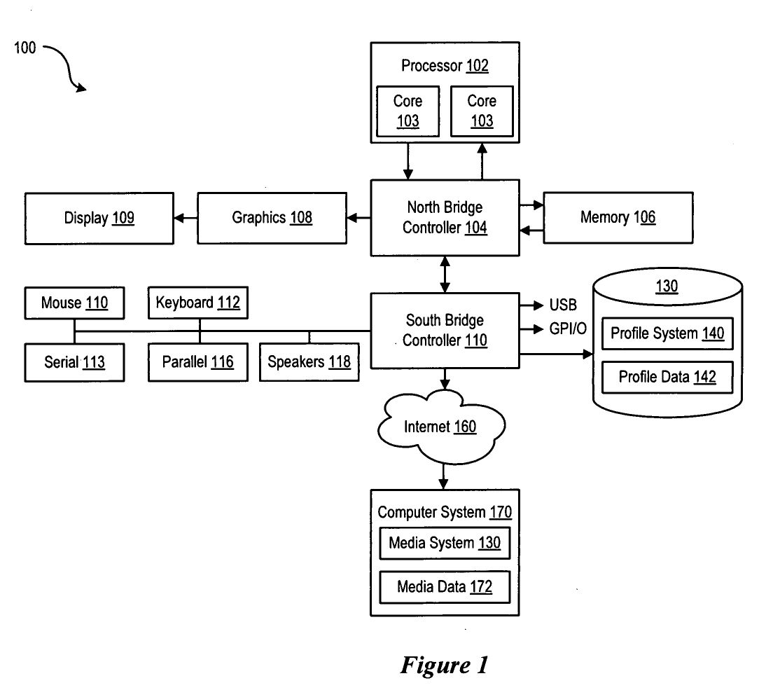

Referring to FIG. 1, a block diagram of a computer system is shown. The computer system 100 includes a processor 102. In certain embodiments, the computer system 100 may include a plurality of processor cores 103. The computer system also includes utilizes a North Bridge Controller (North Bridge) 104 that controls interactions between the processor 102 and system resources such as a system memory 106 and a graphics controller 108 which is coupled to and controls a display 109. The computer system 100 also includes a South Bridge controller (South Bridge) 110 that controls interactions between processor 102 and I/O devices. South Bridge 110 typically has a PCI bus through which peripherals are interfaced to the computer system 100.

The South Bridge controller 110 may be coupled to a mouse 120, a keyboard 122, a serial connector 124, a parallel connector 126, as well as speakers 128. The South Bridge controller 110 may also be coupled to non-volatile memory such as a hard disk drive 130. The non-volatile memory stores a media system 140 that is executed by the processor 102. The non-volatile memory also stores a profile adjustment module 140 as well as associated profile adjustment data 142.

The South Bridge controller may also couple the computer system to the Internet 160, via e.g., a modem such as a wireless or broadband modem. One or more remote computer systems 170 may be coupled to the computer system 100 via the Internet 160. The remote computer system 170 may also include a profile adjustment module 140 as well as profile adjustment data 142.

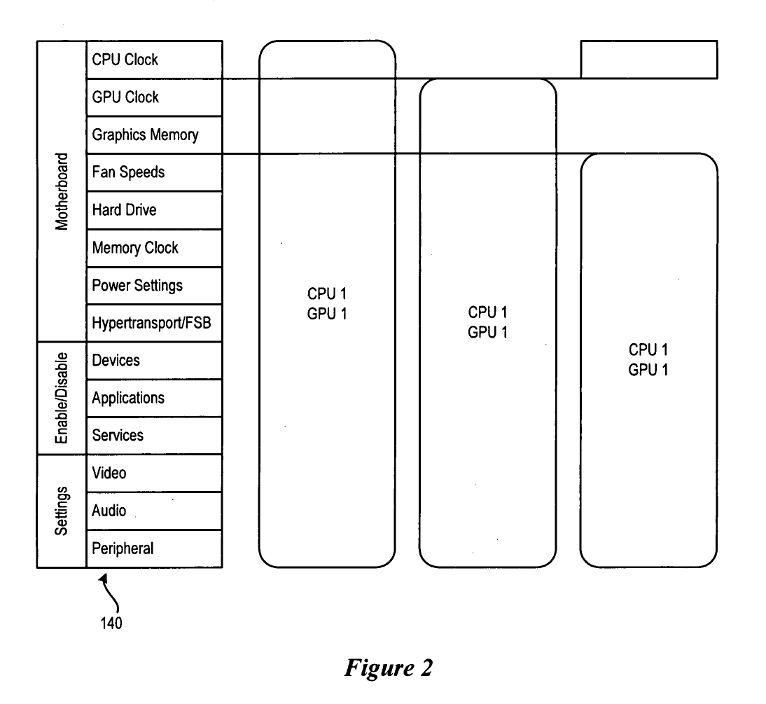

Referring to FIG. 2, a block diagram of the profile adjustment module 140 is shown. More specifically, the profile adjustment module 140 includes a motherboard portion 210, an enable/disable portion 212, and a settings portion 214.

The motherboard portion 210 controls setting a plurality of variables of devices that are located on the motherboard of a computer system. For example, the plurality of variables can include a central processing unit (CPU) clock speed 220, a graphics processing unit (GPU) clock speed 222, graphics memory settings 224, fan speeds 226, hard drive setting 228, memory clock speed 230, power settings 232 and hypertransport front side bus (FSB) settings 234.

The enable disable portion 212 can enable or disable a plurality of components (either hardware or software) within a computer system. For example, the plurality of components can include devices 240, applications 242, and services 244.

The settings portion controls settings for a plurality of components. For example, the plurality of components can include video components 250, audio components 252, and peripheral components 254.

The profile adjustment module 140 can interact and control profiles for a plurality of combinations of devices. For example, the profile adjustment module 140 can interact and control profiles for a first brand of processor (CPU1) and a first brand of graphics processor (GPU1). The profile adjustment module 140 can interact and control profiles for a second brand of processor (CPU2) and a first brand of graphics processor (GPU1). The profile adjustment module 140 can interact and control profiles for a first brand of processor (CPU1) and a third brand of graphics processor (GPU3). If the profile adjustment module 140 is associated with the first brand then it is possible that the highest level of adjustability, and thus the maximum performance enhancement, is available with the first brand of processor and the first brand of graphics processor.

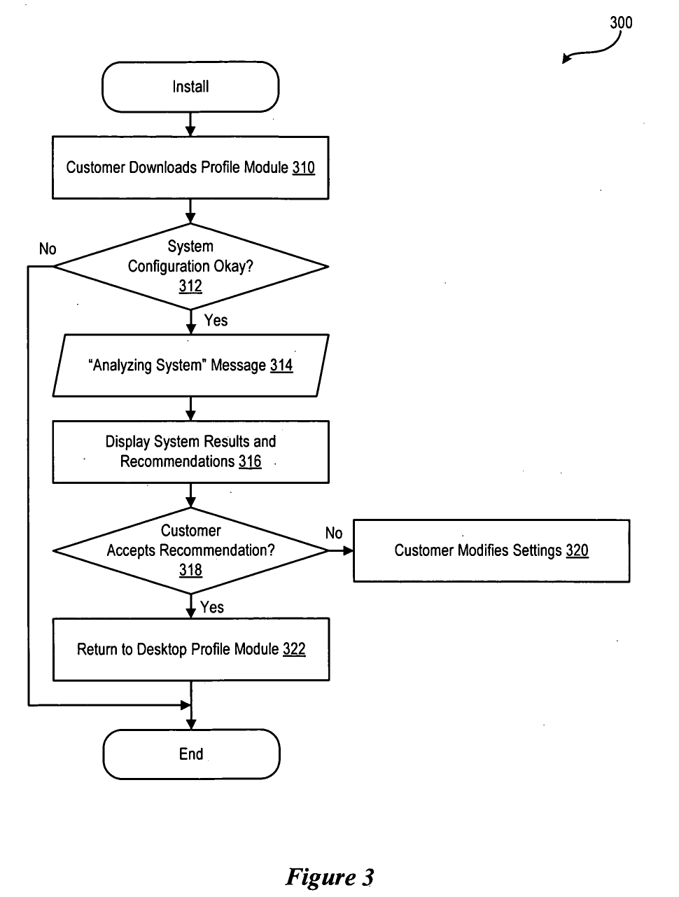

Referring to FIG. 3, a flow chart of the operation of an install portion 300 of a profile adjustment module 140 is shown. More specifically, when an install sequence is executed, the customer loads the profile module 140 onto a computer system at step 310. This install may be accomplished by downloading the profile module from a particular website or may be via some form of local non-volatile memory. Next, an install portion of the profile module 140 determines whether the system configuration of the computer system conforms to predefined requirements for executing the install module at step 312. If the system configuration of the computer system does not conform to predefined requirements for executing the install module 140, then the installation process ends.

If the system configuration of the computer system does conform to predefined requirements for executing the install module 140, then the installation process proceeds the an analyzing operation where the install portion of the profile module 140 analyzes the computer system while presenting an analyzing system message 314. Next, the install portion displays system results as well as profile adjustment recommendations at step 316. The customer can accept the recommendations at step 318. If the customer does not accept the recommendations, then the customer can modify the settings at step 320. If the customer accepts the recommendations, or the customer modifies the setting at step 322, the install portion proceeds to step 322 during which the install portion navigates the computer system back to the desktop and installs a profile module icon on the desktop of the computer system.

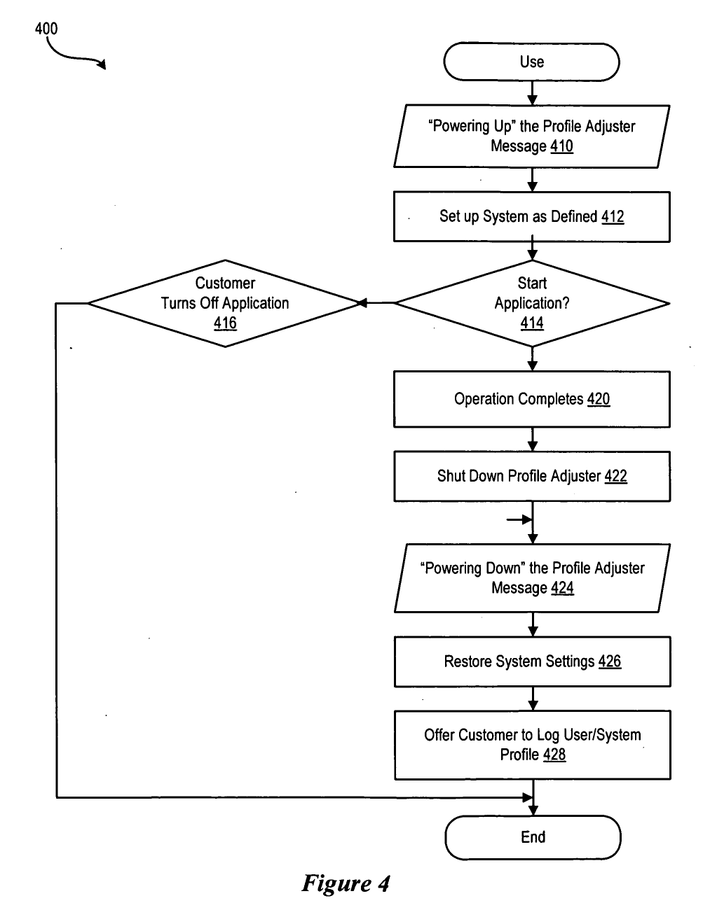

Referring to FIG. 4, a flow chart of the operation of a use portion 400 of the profile adjustment module 140 is shown. More specifically, when the use portion 400 of the profile adjustment module 140 is executed, the profile adjustment module 140 starts operation by presenting a powering up profile adjuster message at step 410. Next, the profile adjustment module configures the computer system as defined by the selected profile at step 412. Next, the profile adjuster determines whether the operation for which the computer system is configured is started at step 414. If the operation is not started, then the profile adjustment module generates a query regarding whether to turn off the profile adjustment module at step 416. If not, then the operation of the profile adjustment module completes.

If the profile adjuster determines that the operation for which the computer system is configured is started, then the profile adjustment module monitors the computer system until the operation completes at step 420. When the operation completes, then the profile adjustment module 140 begins a shut down sequence at step 422. During the shut down sequence, the profile adjustment module 140 presents a powering down profile adjuster message at step 424 and restores the general computer system settings to the computer system at step 426. The profile adjustment module 140 can also provide the user with an option of logging the user and system profile information at step 428.

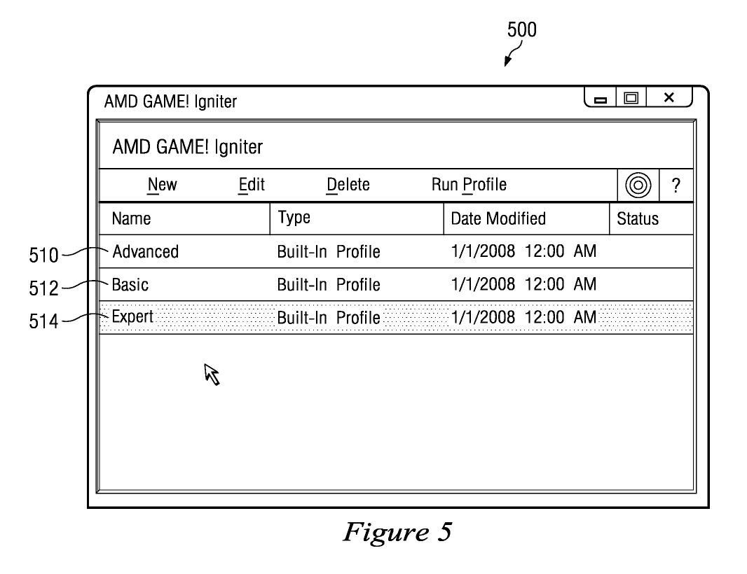

FIG. 5 shows an example screen presentation of a profile selection operation of profile adjustment module. More specifically, the profile adjustment module 140 generates a profile selection screen presentation 500. The profile selection screen presentation 500 provides a user with a plurality of predefined profiles from which the user can select. For example, the profiles can include an advanced profile 510, a basic profile 512, and an expert profile 514. Each of the profiles can include a plurality of settings that are preconfigured for associated operations. Additionally, by actuating the “new” portion of the screen presentation, a user can add additional profiles to the profile selection.

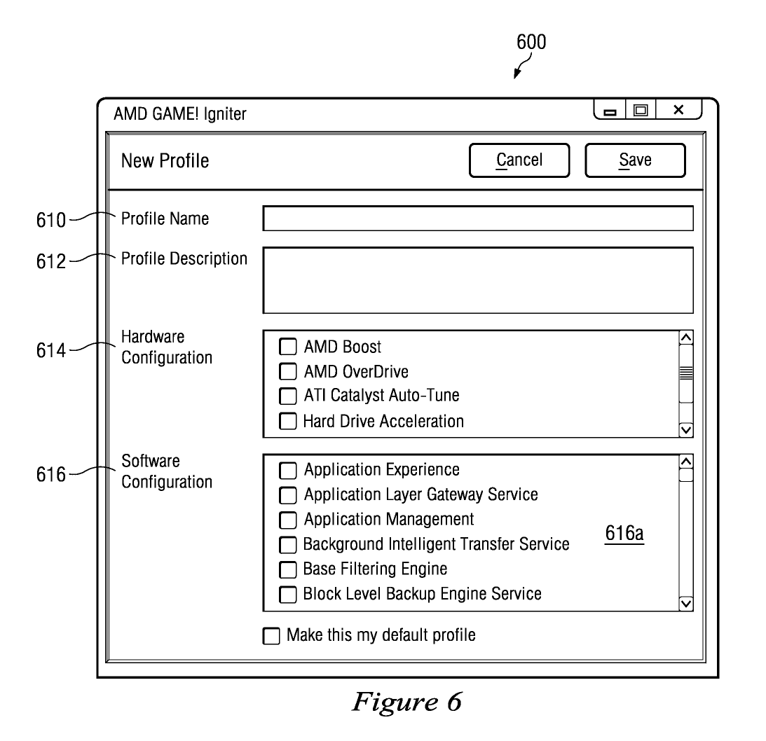

FIG. 6 shows an example screen presentation of a profile creation operation of a profile adjustment module 140. More specifically, when a user elects to add an additional profile, the user is presented with a profile creation screen presentation 600. The profile creation screen presentation 600 includes a profile name portion 610, a profile description portion 612, a hardware configuration portion 614, and a software configuration portion 616. The profile creation screen presentation 600 also includes a default profile indication 620 which allows identification of the profile as a default profile.

The hardware configuration portion 614 enables a user to configure a plurality of hardware configuration options. For example, the hardware configuration options include a boost option, an overdrive option, an auto-tune operation, and a hard drive acceleration option. The software configuration portion 616 enables a user to configure a plurality of software configuration options. For example, the software configuration portion 616 presents a software configuration window screen presentation 616a having a plurality of software configuration options.

The selected hardware configuration options and software configuration options provide a profile that is automatically adjusted via the profile adjustment module 140.

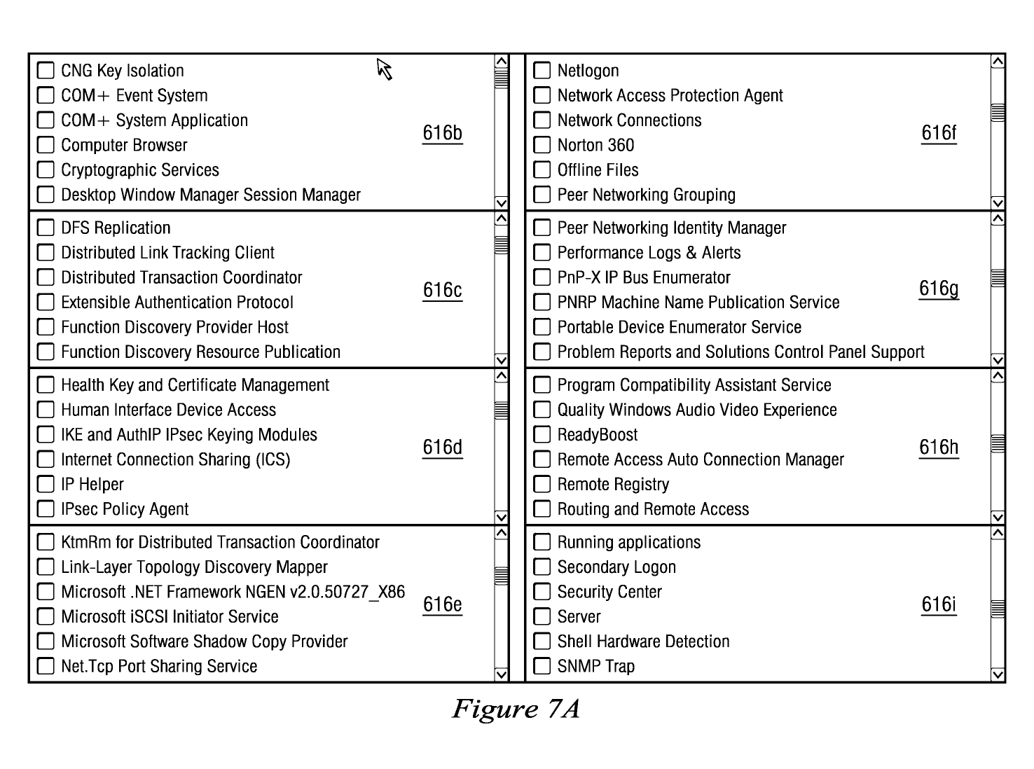

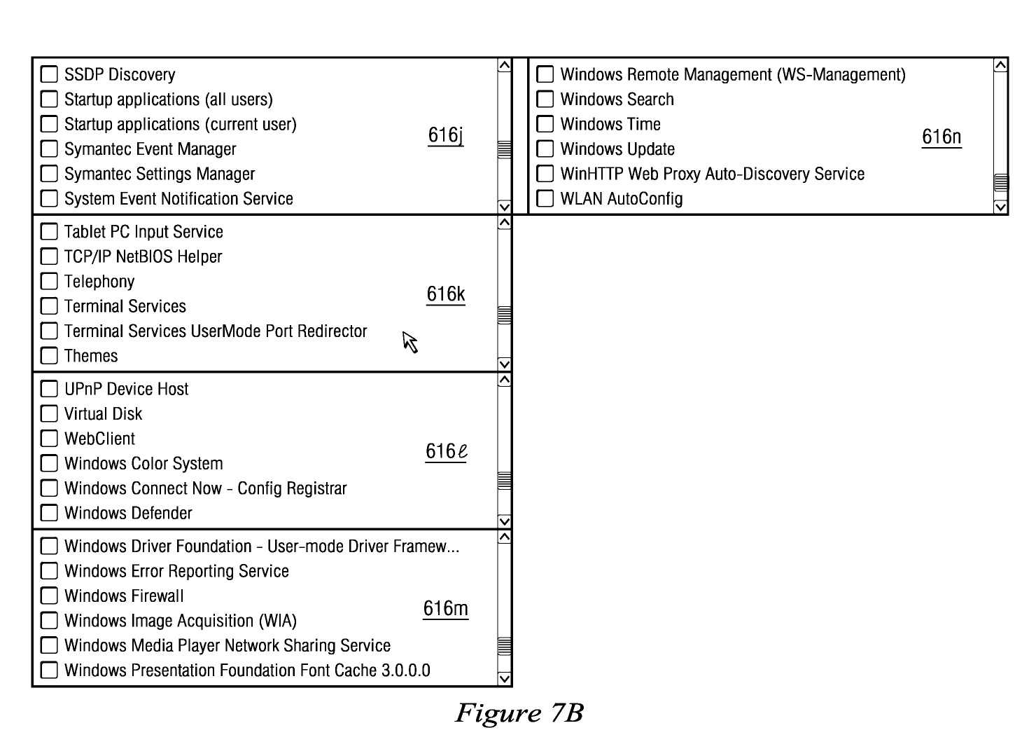

FIGS. 7A and 7B show example screen presentations of software configuration portion 616 of a profile adjustment module 140. More specifically, a plurality of screen presentations (616b, 616c, 616d, 616e, 616f, 616g, 616h, 616i, 616j, 616k, 616l, 616m, 616n), each presenting a plurality of software configuration options, are presented within the software configuration portion 616 as a user scrolls within the software configuration portion 616. A user may elect to individually enable or disable each of the software configuration options via the software configuration portion 616.

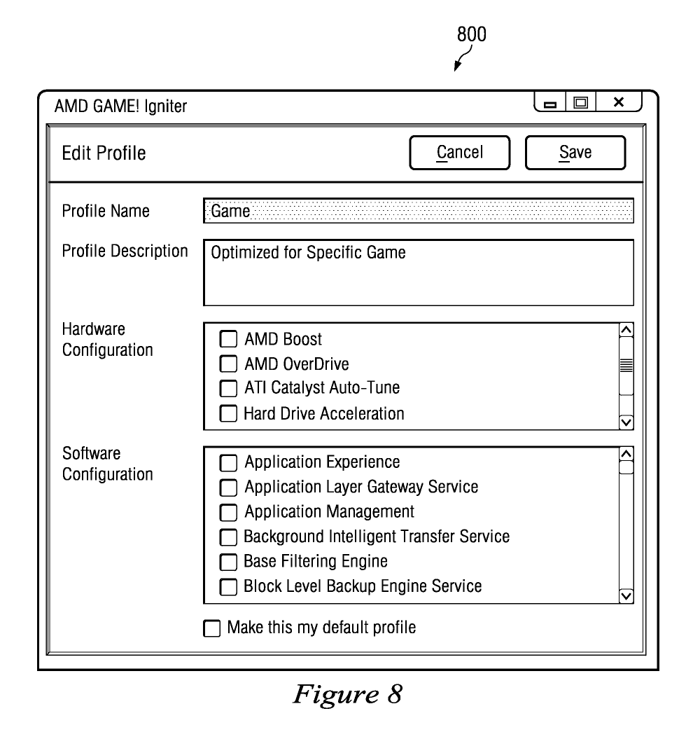

FIG. 8 shows an example screen presentation of an edit profile operation of a profile adjustment module 140. More specifically, when a user elects to edit a profile, the user is presented with an edit profile screen presentation 800. The edit profile screen presentation 800 includes a profile name portion 810, a profile description portion 812, a hardware configuration portion 814, and a software configuration portion 816. The edit profile screen presentation 800 also includes a default profile indication 820 which allows identification of the profile as a default profile.

The hardware configuration portion 814 enables a user to configure a plurality of hardware configuration options. For example, the hardware configuration options include a boost option, an overdrive option, an auto-tune operation, and a hard drive acceleration option. The software configuration portion 816 enables a user to configure a plurality of software configuration options. For example, the software configuration portion 816 presents a software configuration window screen presentation 816a having a plurality of software configuration options.

The selected hardware configuration options and software configuration options provide a profile that is automatically adjusted via the profile adjustment module 140.

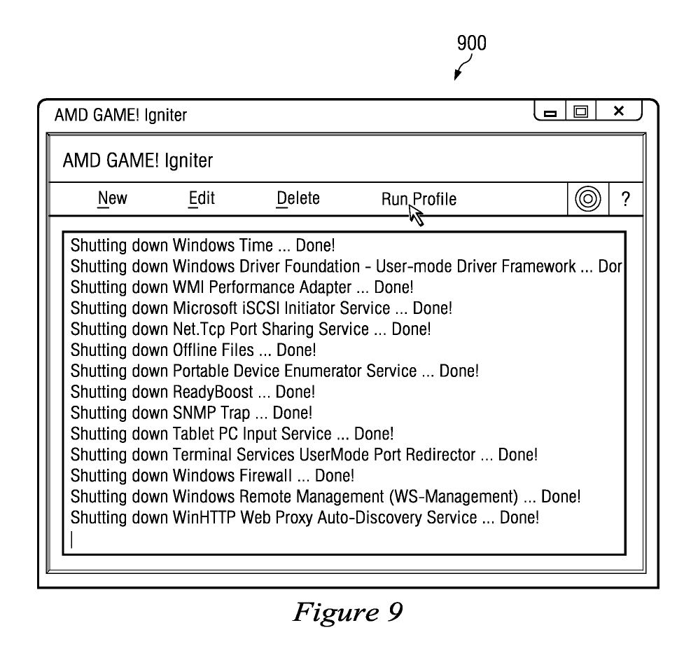

FIG. 9 shows a start and stop profile operation of a profile adjustment module. More specifically, during an operation such as the power down profile adjuster operation 424, the profile adjustment module presents a start/stop profile indication 900 during which information regarding the various operations that are being started or stopped by the profile adjustment module 140 is presented.

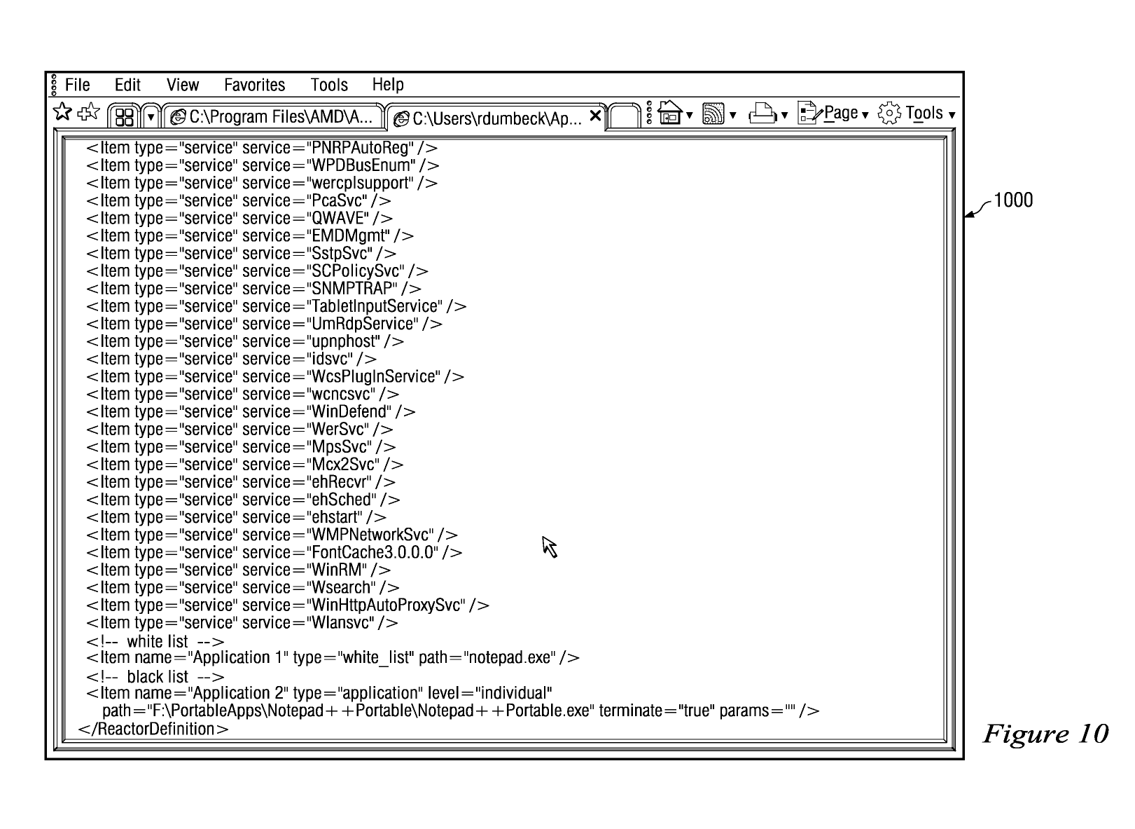

FIG. 10 shows an example screen presentation 1000 of a white list operation of a profile adjustment module. More specifically, suppliers such as hardware suppliers can customize profiles which are included within the profile adjustment module profiles according to their specific hardware. This customization is generated via a white list operation which may be accessed via a white list screen presentation. The white list screen presentation 1000 provides an extensible mark up language (XML) based editor via which suppliers can create system specific profiles.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, profiles may also be adjusted for other usage models such as a battery savings usage model and an energy savings usage model. With a battery saving usage model for example, certain functions could be turned on or off depending on a users desires.

Also for example, the options adjusted by the profile adjustment module can include additional hardware and software configuration options. For example, depending on a particular usage model, the profile adjustment module could disable cores within a processor (such as with a basic web browsing usage model), limit frequency and voltage applied to various hardware components, could set affinity for certain processes (e.g., to allow for single and dual threaded applications), could place a hard disk drive (or other storage devices) into a low power state, could divert power back and forth between a processor and a graphics processor depending on load, could turn of system resource hogs (such as indexers, an Aero application, a Sidebar application, transcoders or antivirus scans), could shut down blue tooth functionality or wireless functionality (such as for an airplane usage model), could add automatic options based upon monitoring of event notifications (e.g., the module could turn off an Aero application or a SideBar application when a user unplugs a system from AC power), and could take advantage of a Power Express Feature for a desktop (such as when a user enters into a low power or Web mode of operation, the profile adjustment module could shut off discrete graphics and use integrated or clocked down integrated graphics for the less graphics intensive mode of operation.)

Also, for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably, or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module. Consequently, the invention is intended to be limited only by the spirit and scope of the appended claims, giving full cognizance to equivalents in all respects.

What is claimed is:

1. A method of customizing a profile of a computer system comprising:
providing the computer system with a plurality of predefined finely tuned profile settings, each of the plurality of predefined finely tuned profile settings corresponding to a particular usage model;
enabling a user to select one of the plurality of predefined finely tuned profile settings based upon a desired usage model;
customizing operation of the computer system based upon the one of the plurality of predefined finely tuned profile settings so as to optimize operation of the computer system for the desired usage model.

2. The method of claim 1 wherein the customizing further comprises:
initiating a predetermined sequence of events to optimize operation of the computer system for the desired usage model.

3. The method of claim 2 wherein:
the predetermined sequence of events comprises tuning the audio and video settings to peek experience settings, the peek experience settings corresponding to the desired usage model.

4. The method of claim 1 wherein the customizing further comprises:
turning off unneeded applications and services not used for the desired usage model.

5. The method of claim 1 further comprising:
restoring the computer system to an original profile configuration upon completion of execution of the usage model.

6. The method of claim 1 further comprising:
accessing an online profile adjustment component, the online profile adjustment component allowing users to access system configurations and game settings for downloading additional finely tuned profile settings.

7. An apparatus for customizing a profile of a computer system comprising:
means for providing the computer system with a plurality of predefined finely tuned profile settings, each of the plurality of predefined finely tuned profile settings corresponding to a particular usage model;
means for enabling a user to select one of the plurality of predefined finely tuned profile settings based upon a desired usage model;
means for customizing operation of the computer system based upon the one of the plurality of predefined finely tuned profile settings so as to optimize operation of the computer system for the desired usage model.

8. The apparatus of claim 7 wherein the means for customizing further comprises:
means for initiating a predetermined sequence of events to optimize operation of the computer system for the desired usage model.

9. The method of claim 8 wherein:
the predetermined sequence of events comprises tuning the audio and video settings to peek experience settings, the peek experience settings corresponding to the desired usage model.

10. The apparatus of claim 7 wherein the means for customizing further comprises:
means for turning off unneeded applications and services not used for the desired usage model.

11. The apparatus of claim 7 further comprising:
means for restoring the computer system to an original profile configuration upon completion of execution of the usage model.

12. The apparatus of claim 1 further comprising:
means for accessing an online profile adjustment component, the online profile adjustment component allowing users to access system configurations and game settings and to download additional finely tuned profile settings.

13. A system stored a computer readable medium, the system comprising instructions executable by a processor for:
providing the computer system with a plurality of predefined finely tuned profile settings, each of the plurality of predefined finely tuned profile settings corresponding to a particular usage model;
enabling a user to select one of the plurality of predefined finely tuned profile settings based upon a desired usage model;
customizing operation of the computer system based upon the one of the plurality of predefined finely tuned profile settings so as to optimize operation of the computer system for the desired usage model.

14. The system of claim 13 wherein the instructions for customizing further comprise instructions for:
initiating a predetermined sequence of events to optimize operation of the computer system for the desired usage model.

15. The system of claim 14 wherein:
the predetermined sequence of events comprises tuning the audio and video settings to peek experience settings, the peek experience settings corresponding to the desired usage model.

16. The system of claim 13 wherein the instructions for customizing further comprise instructions for:
turning off unneeded applications and services not used for the desired usage model.

17. The system of claim 13 wherein the instructions for customizing further comprise instructions for:
restoring the computer system to an original profile configuration upon completion of execution of the usage model.

18. The system of claim 13 wherein the instructions for customizing further comprise instructions for:
accessing an online profile adjustment component, the online profile adjustment component allowing users to access system configurations and game settings for downloading additional finely tuned profile settings.
